(19) United States
(12) Patent Application Publication
(10) Pub. No.: US 2024/0417050 A1
(43) Pub. Date: Dec. 19, 2024

(54) Boat Attachment System

(71) Applicants: David Redden, Windor Junction (CA); Maurice Guitton, Lunenburg (CA)

(72) Inventors: David Redden, Windor Junction (CA); Maurice Guitton, Lunenburg (CA)

(21) Appl. No.: 18/745,886

(22) Filed: Jun. 17, 2024

Related U.S. Application Data
(60) Provisional application No. 63/521,482, filed on Jun. 16, 2023.

(51) Int. Cl. B63H 20/02; F16B 2/06

(52) U.S. Cl. CPC B63H 20/02; F16B 2/06

(57) ABSTRACT

A boat attachment system for mounting electric motors, small engines, or other accessories to a boat's transom or gunnel. The system includes at least one clamp with two mounting arms pivotally attached at their heads with a locking hinge. A pivoting clamping arm is attached to the lower end of each mounting arm. During use, the two mounting arms and clamping arms are vertically aligned over the boat's transom or gunnel and locked together around the transom or gunnel. The clamping arms are adjusted and locked in a fixed position to press tightly against the inside and outside surfaces of the transom or gunnel. A support bar is attached to the head sections on the two mounting arms. An accessory support bar may be attached to a single clamp that attaches to a connect to a horizontally aligned accessory bar configured to hold fishing rods, beverage containers, or cell phones.

### REFERENCES TO RELATED APPLICATIONS

This utility patent application is based on and claims the filing date benefit of U.S. Provisional Patent Application (63/521,482) filed on Jun. 16, 2023.

### FIELD AND BACKGROUND OF THE INVENTION

### Field of the Invention

This invention pertains to systems for attaching motors, engines or other accessories to the transom or gunnel of a boat and, more particularly, to such systems specifically designed to be quickly attached or detached to the boat that does not require modification to the boat nor the use of large or heavy hand tools.

### BACKGROUND OF THE INVENTION

Trolling is a fishing method where a fisherman trails a baited hook or lure behind a moving boat. The bait mimics the movement of prey, enticing fish to bite.

When trolling on small lakes, fishermen often use a quiet, lightweight electric motor or gas engine mounted on the boat's transom. Most prefer attaching the motor to the transom due to its space-saving design and shorter shaft length. However, if the boat's bow height matches the stem or the shaft is long enough, some fishermen may attach the motor to the bow or gunnel. This allows them to control the motor while standing near the bow.

When attaching the trolling motor or engine to the transom, clamps on the motor or engine bracket straddle the transom to securely attach the motor or engine to the transom. The clamps must be tightened to firmly attach the trolling motor or engine. Often, hand tools are required to tighten the clamps, which may not be available.

For small boats without a transom or an engine bracket, directly attaching a trolling motor or engine to the boat's gunnel is often not an option. While attaching a trolling motor or engine may be the boat's gunnel may appear to be an optional structure, most motor and engine brackets cannot be attached to a boat gunnel.

Fishermen use various fishing rods, each with different lures or baits, which they have set up before fishing. If the current rod isn't catching fish effectively, they swiftly replace it with another previously prepared rod. However, the number of pre-set rods is restricted due to the limited rod holders on small boats used for troll fishing.

During extended fishing trips, many anglers carry beverage containers and cell phones. However, small boats used for trolling fish lack built-in cup holders or cellphone holders. As a result, fisherman often stores their beverage containers and cell phones in their pockets or fishing bags. Later, they are placed on the boat's seat or bench, leading to spills or accidental drops when the boat rocks.

What is needed is a boat attachment system that allows a fisherman to easily and quickly attach a trolling motor or engine to the transom, the bow, or the gunnel.

What is also needed is a boat attachment system that does not require the use of heavy hand tools, such as a crescent wrench, pliers, or socket wrench.

What is also needed is a boat attachment system that is adjustable for use on used with various transoms, bows, and gunnels that have different shapes or angular profiles.

What is also needed is a boat attachment system that can be easily modified to securely hold multiple fishing rods or other objects, such as fishing rods, beverage containers, or cellphones, to the transom, bow, or gunnel.

### SUMMARY OF THE INVENTION

The boat attachment system meets these and other objects for mounting a trolling motor to a boat's transom, bow, or gunnel.

The boat attachment system includes at least one clamp with two mounting arms. The two mounting arms are pivotally attached at their head sections with a locking hinge. Attached to the lower leg on each mounting arm is a pivoting clamping arm. Each mounting arm has a lower leg to which a pivoting clamping arm is attached. The two mounting arms extend over the top surface of the transom or gunnel. Each mounting arm includes a head section that extends above the top surface of the transom or gunnel. The two clamping arms extend downward on opposite sides of the transom or gunnel and press tightly inward to hold each clamp in place.

More specifically, the two mounting arms are z-shaped and include an upward-extending head section and a lower leg section. The two head sections on the two mounting arms are pivotally connected via a threaded bolt. The two leg sections are configured to extend over and around the opposite sides of a transom or gunnel. When the mounting arms are rotated and forced together, the two head sections are parallel and form a center void configured to fit around the top edge of a transom or gunnel.

Each clamping arm includes a cylindrical body and a curved wing element. The cylindrical body is pivotally attached via a locking bolt to the distal end of the adjacent mounting arm. During use, the user rotates the clamping arm on each mounting arm to press tightly against the surfaces of the transom or gunnel. The locking bolt may be biased to automatically force the two clamping arms inward to hold the clamp in place.

On each clamp, the two mounting arms are closed, and the two clamping arms are individually adjusted to press tightly against the inside and outside surfaces of the transom or gunnel. In one embodiment, a rigid short support bar is horizontally aligned and attached at or near its center axis to one end of the head sections of a single clamp. During use, the short support bar is aligned axially and horizontally over the top surface of the transom or gunnel. After the short support bar is attached to the clamp, an engine or motor clamp may be attached to the support bar.

If the trolling motor is heavy, two clamps may be used, which are spaced apart and attached to the transom or gunnel. In this embodiment, the short support bar is replaced by a long support bar that extends between the two clamps. The opposite ends of the support bar are attached to the head sections on the two clamps.

In another embodiment, the short support bar is attached to one clamp, and the short support bar is rotated 90 degrees to extend transversely from the transom or gunnel. A holding bar for fishing rods, beverage containers, or cell phones may be attached to the end of the short bar. The holding bar may include a plurality of holes, each configured to hold an accessory.

### BRIEF DESCRIPTION OF DRAWINGS

FIG. 1 is a perspective view of the boat attachment system that uses one clamp and a short support bar oriented axially over the transom, bow, or gunnel of a boat.

FIG. 2 is a perspective view of the attachment system shown in FIG. 1, showing the engine clamps attached to the short support bar.

FIG. 3 is a front view of a clamp in an open position that includes two pivotally attached mounting arms, each with a pivoting clamp member.

FIG. 4 is a front view of a clamp shown in FIG. 3 in a closed position around the top edge of a transom.

FIG. 5 is a perspective view of the first mounting arm.

FIG. 6 is a perspective view of the second mounting arm.

FIG. 7 is a perspective view of one clamping arm.

FIG. 8 is a perspective view of a wide clamping arm.

FIG. 9 is a rear elevational view of the transom showing two clamps mounted on the transom and a long support bar extending between the two clamps.

FIG. 10 is a side perspective view of an accessory bar mounted on a clamp and extended into the boat with a holding bar attached to the accessory bar configured to hold fishing rods, beverage containers, or cell phones.

FIG. 11 is a perspective view of an alternative accessory bar with holes to hold fishing rods and holes to hold a beverage container.

### DETAILED DESCRIPTION OF THE INVENTION

Referring to the accompanying FIGS., a boat attachment system 10 is shown for mounting a lightweight trolling motor (or engine) 100 to a boat's transom 90 or gunnel 95. The attachment system 10 includes at least one clamp 12 with first and second mounting arms 20, 40 pivotally attached at their heads with a locking bolt 32. A pivoting clamping arm 60 is attached to the lower end of each mounting arm, 20, 40. During use, the two mounting arms 20, 40 are aligned over the top surface 91 of the boat's transom 90 or gunnel 95. The mounting arms 20 and 40 are then closed over the top transom 90 or gunnel 95, and the clamping arms 60 are then individually adjusted and pressed tightly against the inside and outside surfaces 92, 93, respectively, of the transom 90 or gunnel 95 to lock the clamp 12 in a fixed position.

The two mounting arms 20, 40 on each clamp 12 are z-shaped and include an upward-extending head section 21, 41, and a lower leg section 25, 47, respectively. The two head sections 21, 41 are pivotally connected via a threaded bolt 32. The head section 21 on the first mounting member 20 includes a single ear 22 with a center hole 23. Head section 41 on second clamp member 40 includes two ears 42, 44 separated by a slot 47. Formed on each ear 42, 44 is a hole 43, 45, respectively. Hole 45 is threaded. During assembly, ear 22 is inserted into slot 47 so that holes 22, 43, and 45 are axially aligned. Locking bolt 32 is then inserted into holes 23 and extended into holes 43 and 45.

When the two mounting arms 20 and 40 are closed, a void 30 is created fits over the top surface of a transom or gunnel. Locking bolt 32 is then tightened to affix the mounting arms 20 and 40 around the transom or gunnel. The lower leg sections 25 and 47 extend downward over the inside and outside surfaces of the transom or gunnel.

Each clamping arm 60 includes two ears 62, 64 and an integrally formed curved wing 68. The two ears 62 and 64 are spaced apart, thereby creating a slot 66 between them. Each ear 62, 64 also includes a hole 63, 65, respectively. Hole 65 is threaded. During assembly, the two ears 62, 64 are disposed around ears 26, 48 located on the lower end of the mounting arms 20, 40 respectively. The holes on the ears 26, 48 are aligned with the holes 23, 49 in the ears 22, 48 respectively. A locking bolt 32 is then inserted into the holes 23, 63, and 65 and tightened. During use, the user rotates the clamping arm 60 on each mounting arm 20, 40 to press tightly against the surfaces of the transom or gunnel. The user then uses his finger or a screw driver to tighten the locking bolt 32 to lock the clamping arms 60 in place. Bolt 32 may include a spring that provides a biasing force that automatically forces the two clamping arms 60 inward to hold the clamp in place.

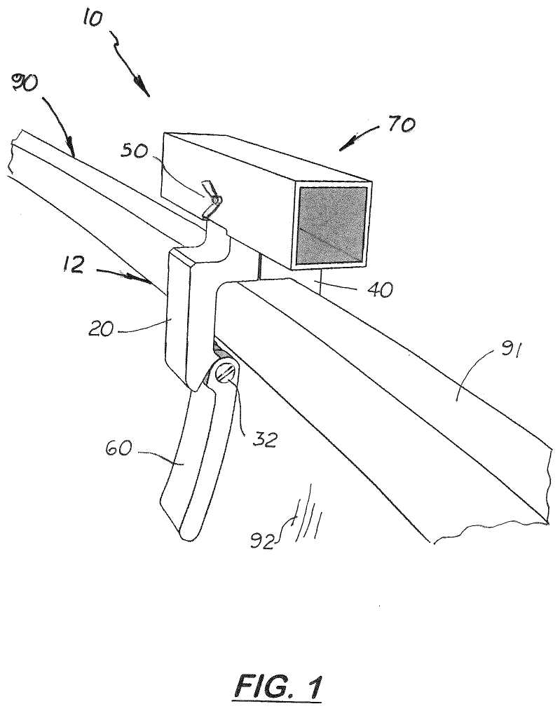

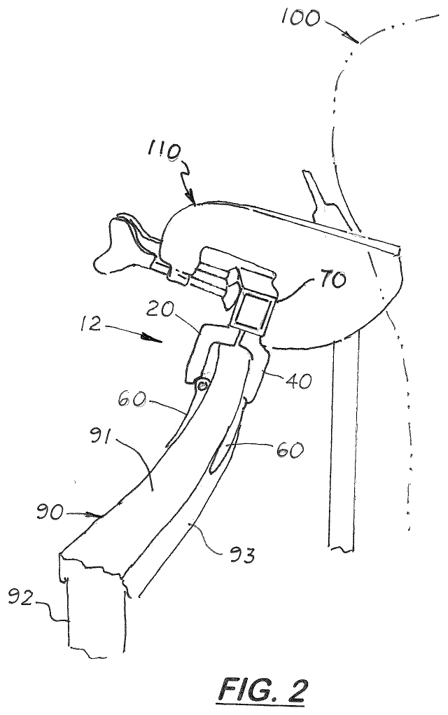

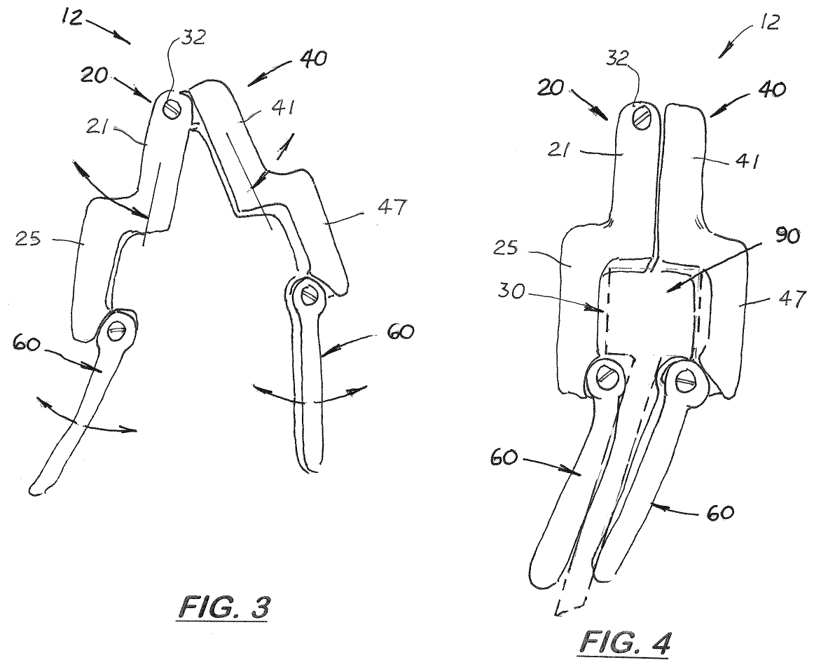

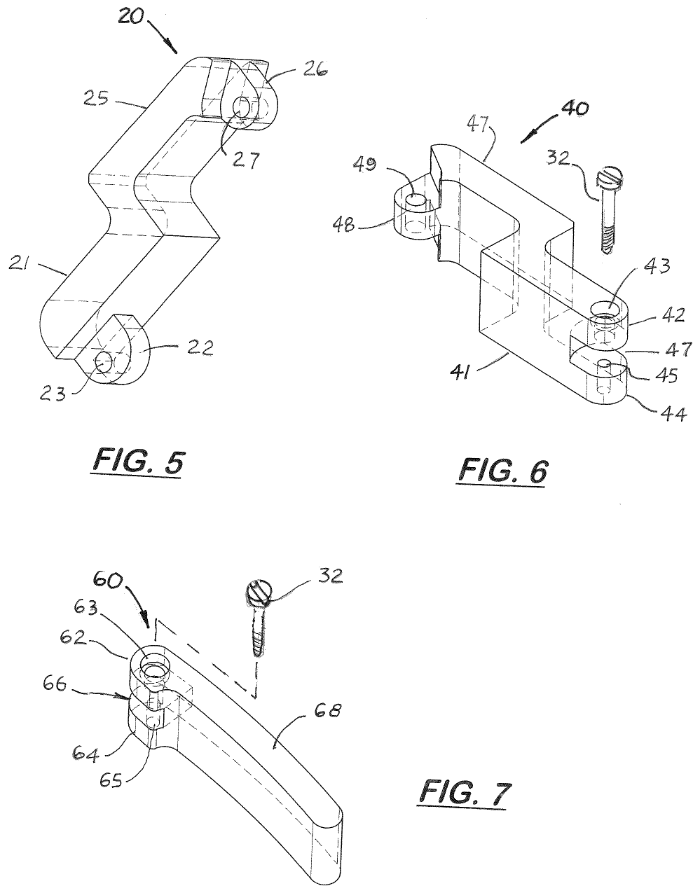

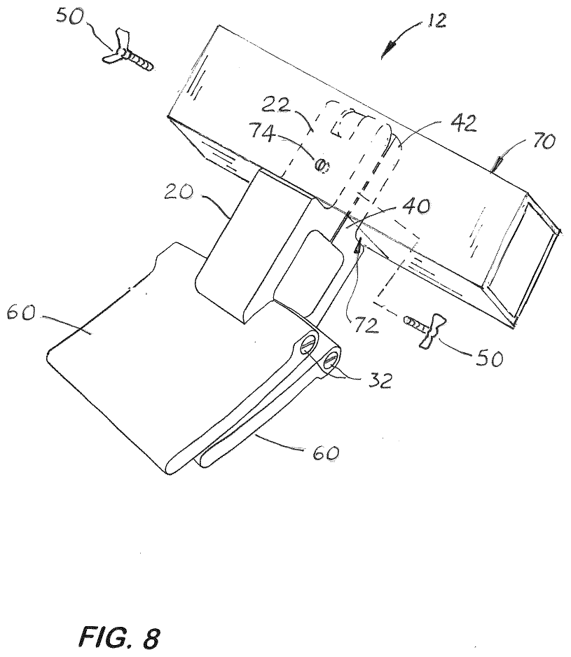

In one embodiment shown in FIGS. 1 and 3, and 8, one clamp 12 is attached to the transom or gunnel and a single short, rigid support bar 70, is horizontally aligned and attached at one end to the heads of the two mounting arms 20, 40 as shown in FIG. 1, As shown in FIG. 2, clamps used on an engine bracket 110 attached to an engine 100 are used to attach the bracket 100 to the support bar 70. FIG. 8 shows the head sections 22, 42 of the clamp 12 being inserted into a head receiving cavity 72 formed on the bottom of the support bar 70. Two wing bolts 50 are inserted into holes 74 formed on opposite sides of the support bar 70 that press against the sides head sections 22, 42 to affix the support bar 70 to the head sections 22,44.

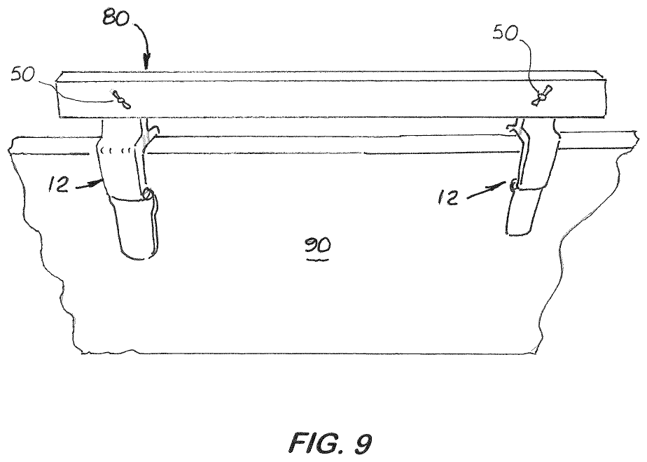

FIG. 9 shows another embodiment of the system 10 that uses two clamps 12 spaced apart on the transom or gunnel 90. A long support bar 80 is extended over the transom or gunnel and attached at its opposite ends to a clamp 12. Wing bolts 50 are used to attach the long support bar to each clamp 12.

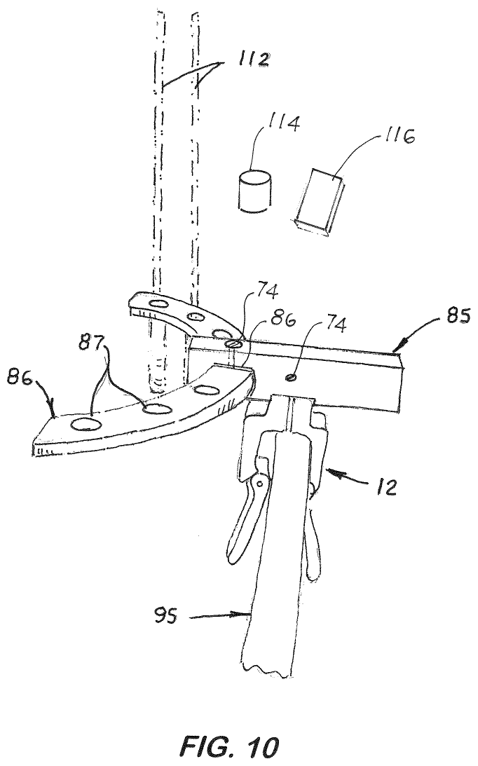

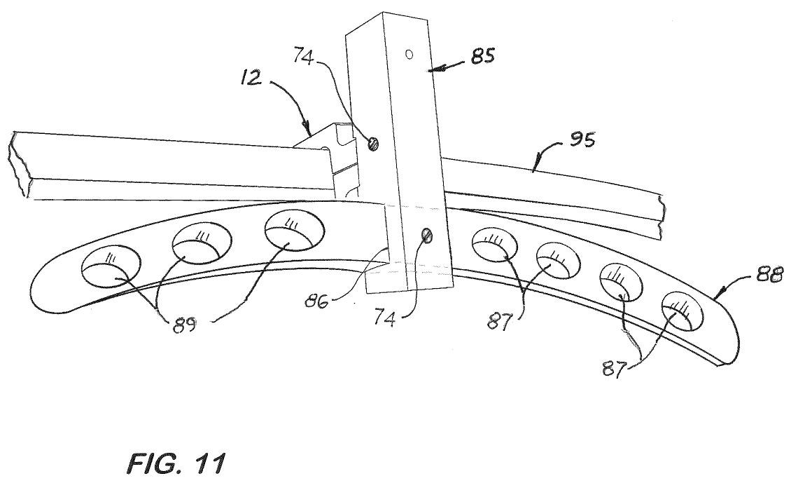

FIGS. 10 and 11 show an accessory holding bar 85 mounted on an accessory support bar 85 transversely aligned over clamp 12. The accessory support bar 85 includes a slot 86 that receives the accessory holding bar 88. A bolt 74 extends downward from the accessory support bar 85 and connects to the accessory holding bar 88. The accessory holding bar 88 is a curved bar with a plurality of holes 87 formed therein configured to receive a fishing pole 112, a beverage can 114 or a cell phone 116.

The clamp 12 is approximately 6 to 12 inches in length and 1 to 3 inches wide. When installed on a transom or gunnel, the head section of each mounting arm 21, 42 extends approximately 1 to 3 inches above the transom or gunnel. Each clamping arm 60 is approximately 3 to 12 inches in length and 2 to 12 inches in width.

The support bar 70, 80 and 85 are made of aluminum or galvanized steel and square or rectangular in cross-section. Support bar 70 and 85 measure approximately 1 to 2 inches in width and 12 to 24 inches in length. Support bar 80 measures approximately 30 to 48 inches in length.

During use, one or two clamps 12 are attached to a desire location on the transom or gunnel. The two mounting arms, 20 and 40, are then closed and locked in position. The clamping arms 60 are then pressed inward against the side of the transom or gunnel. The desired support bar 50, 80 or 85 is then placed over the head sections of the mounting arms and securely attached thereto. An engine bracket or accessory support bar may be attached to the support bar.

In compliance with the statute, the invention described has been described as more or less specific to structural features. It should be understood, however, that the invention is not limited to the specific features shown since the means and construction shown comprise the preferred embodiments for putting the invention into effect. The invention is therefore claimed in its forms or modifications within the legitimate and valid scope of the amended claims, appropriately interpreted under the doctrine of equivalents.

We claim:

1. A boat attachment system for attaching an electric motor, a small engine or an accessory to the transom or gunnel on a boat, comprising:
a. a clamp that includes
a first mounting arm that includes a head section and a lower section, said lower section said being configured to partially extend the side of a transom or gunnel, said lower section extends downward and presses against said side of said transom or gunnel;
a second mounting arm that includes a head section and a lower section, said lower section said being configured to partially extend the side of a transom or gunnel, said lower section extends downward and presses against said side of said transom or gunnel;
an upper locking hinge disposed between said upper head sections configured to s pivotally attached said first mounting arm and said second mounting arms together;
a clamping arm attached to said lower section on said first mounting arm;
a second clamping arm attached to said lower section of said second mounting arm; and,
b. a support bar attached to said head sections when said first and said second mounting arms are in a closed position around said transom or said gunnel.

2. The boat attachment system as recited in claim 1, wherein said support bar is transversely aligned with said clamp.

3. The boat attachment system as recited in claim 2, wherein said support bar is centrally aligned over said clamp.

4. The boat attachment system, as recited in claim 2, further includes a second clamp, and said support bar extending between the said clamp and said second clamp.

5. The boat attachment system as recited in claim 2, further including an accessory support bar attached to said support bar and an accessory holding bar attached to said accessory support bar, said accessory holding bar includes a plurality of holes configured to support a fishing rod, or a beverage container or a cell phone.

6. A boat attachment system, comprising:
a. a clamp that includes two pivoting mounting arms pivoting configured to fit over the top edge of a transom or gunnel, each said mounting arm includes a head section and a lower leg,
b. a pivoting clamp member attached to each said lower leg on said mounting arm; and,
c. a support bar attached to said head sections when said first and said second mounting arms are in a closed position around said transom or said gunnel.

7. The boat attachment system as recited in claim 6, wherein said support bar is transversely aligned with said clamp.

8. The boat attachment system as recited in claim 6, wherein said support bar is centrally aligned over said clamp.

9. The boat attachment system mounting as recited in claim 6, further including an accessory support bar attached to said support bar and an accessory holding bar attached to said accessory support bar, said accessory holding bar includes a plurality of holes configured to support a fishing rod, or a beverage container or a cell phone.
